(19) United States
(12) Patent Application Publication
(10) Pub. No.: US 2002/0184514 A1
(43) Pub. Date: Dec. 5, 2002

(54) Apparatus for the sealable storage of objects, and method for purchasing objects

(76) Inventor: Hermann Granzer, Poecking (DE)

Correspondence Address: Bell, Boyd & Lloyd LLC, P.O. Box 1135, Chicago, IL, 60690-1135, US

(21) Appl. No.: 10/151,523

(22) Filed: May 20, 2002

(30) Foreign Application Priority Data
May 23, 2001 (EP) 01112581.2

(51) Int. Cl. H04L 9/00

(52) U.S. Cl. 713/193; 713/170

(57) ABSTRACT

An apparatus is disclosed for the sealable storage of objects, which has a device for checking an opening authorization, is additionally set up to allow opening only following positive authentication of a user, and which has an associated account facility which can be credited with at least one credit sum corresponding to the value of the stored objects. A method is also disclosed for purchasing objects using such an apparatus for storing objects.

### BACKGROUND OF THE INVENTION

The present invention relates to an apparatus for the sealable storage of objects, as well as to a method for purchasing objects, particularly for electronically purchasing objects which can be selected using an electronic purchasing station.

With the increasing spread of the Internet and the large number of users, many firms, etc., have become more interested in purchasing products, services, etc., over the Internet. Enormous growth figures have been and are recurrently predicted for this “e-commerce”, but the reality appears such that many firms offer the opportunity for e-commerce only reluctantly or not at all, and for many users too the prohibitive threshold is often considerable for ordering goods over the Internet.

The development of e-commerce is currently suffering from a number of aspects. It is necessary to ensure that the goods are paid for. One simple way of doing this, namely purchasing by credit card, is not used willingly by the users, since many regard this as being too unsafe, and the credit card data easily can be found out by unauthorized parties during the transfer operation on the Internet. Debit procedures hold a degree of uncertainty for the vendor, since the purchaser can easily transfer the money back again, or else the account may not have sufficient funds.

Apart from the case of products which can be sent over the Internet, such as software, it is also necessary to deliver the ordered products to the purchaser. This, in turn, entails additional cost for the supplier, since a certain amount of logistics are required for dispatch, dispatch costs are incurred and also other costs for additional personnel arise.

By way of example, it is known for larger grocery chains that goods can be ordered from them over the Internet, which goods are then delivered within a particular period of time, normally 24 hours. In this case, besides the personnel costs, the vendor also incurs vehicle costs, which are normally passed on to the purchaser, wherein only orders above a certain, normally relatively high, sum are worthwhile to the purchaser.

Another drawback of the example cited above is that this type of dispatch is not or is only seldom suitable for highly perishable goods; for example, due to the long delivery time.

In principle, it can be argued that, particularly for goods used on a daily basis, such as groceries, the ordering and delivery described above is not absolutely necessary, aside from a few exceptions, such as older or physically handicapped people. However, it would be beneficial for a lot of people, such as for people in employment, if goods can be requested easily, such as by telephone or, better still, over the Internet, using e-mail, SMS or WAP services, etc., and then can be received at a time which is suitable for the purchaser.

For the ordering process, the suppliers need merely have appropriate provision for ordering the goods, for example an “electronic shop”, for this purpose, so that the interested party can order the appropriate goods. However, there is no way known to date for handing over the goods without encountering the problems cited above; for example, concerning payment, delivery expenses, long time, etc.

It is an object of the present invention to provide a method and apparatus which can be used to hand over goods without the aforementioned drawbacks.

### SUMMARY OF THE INVENTION

This object is achieved via an apparatus as mentioned in the introduction in that, according to the present invention, it

has a device for checking an opening authorization,

in that it is also set up to allow opening only following positive authentication of a user, and

in that it has an associated account facility which can be credited with at least one credit sum corresponding to the value of the stored objects.

The inventive apparatus makes it possible for goods ordered from the vendor to be sealed in the apparatus by the vendor. The apparatus then can be opened only by a person who is authorized to do so, for which purpose the person needs to identify himself/herself to the apparatus. In addition, the apparatus also “invoices” the costs for the goods ordered, and the objects can be removed, or the apparatus can be opened, only if this payment actually can be made or an appropriate account of the purchaser has sufficient funds.

The present invention, which is particularly suited to the sale of perishable goods, such as groceries, provides advantages both for the purchaser and for the vendor. The purchaser can order the goods conveniently and easily, and it is not necessary, by way of example, to spend a relatively long time in an appropriate shop, to look for the goods and to wait a relatively long time at the fresh produce section or at the checkout, for example. The goods can be picked up at a time suited to him/her. Payment no longer involves any elements of uncertainty, since it is not made using a credit card, for example, but rather directly when removing the goods from the apparatus.

For the vendor, the costs for dispatch disappear, he/she can put together an ordered range of goods at a time at which there is only a low frequency of customers in his/her shop, for example, and also the uncertainties concerning payment are dispelled for the vendor as well.

It is expedient in this context if the inventive apparatus is set up such that opening is possible only after the credit sum has been credited, or it is set up to credit the credit sum at the moment of opening. This ensures maximum certainty for the vendor, since the goods become accessible to a purchaser only when he/she has actually paid for them.

It is advantageous if the account facility is separate from the apparatus and is connected thereto via a data line, which affords a high degree of flexibility for the present invention and allows an account facility to be used together with a number of inventive apparatuses.

By way of example, in one embodiment of the present invention, the account facility contains at least one trader memory card which is credited with the credit sum, or the account facility is essentially a trader memory card. In this embodiment, a purchaser is able to make the payment using a cash-dispenser or EC card. The purchaser's account is debited by an appropriate sum, and the sum is credited to the trader memory card. The trader then can have this sum credited, usually at regular intervals, to an account held at a bank.

For the payment and/or authentication processes with the apparatus, it is advantageous if the apparatus has at least one reading device for customer memory cards. This customer card then can be used for payment and/or authentication.

For payment processes, it is advantageous in this regard if the reading device can be connected to the account facility, and the goods value is credited using the memory card.

In addition, this also allows the opening authorization to be checked using the memory card. If the memory card is a cash-dispenser card (EC card), for example, payment cannot be made until the user of this card has input an appropriate code associated with the card, and this code has been checked. Accordingly, this procedure can be used for authentication with the inventive apparatus by linking the opening authorization for the apparatus to the memory card, so that opening is possible only for the “holder” of a particular memory card.

For inputting a code associated with a memory card, it is advantageous if the apparatus has at least one input unit.

In this context, it is particularly expedient if the inventive apparatus is also set up to compare an identifier which has been input using the input unit with an identifier (PIN code, password) stored on the memory card.

This allows authentication to take place using, by way of example, the PIN code or a password associated with the memory card. Normally, however, the situation is such that, as in the case of EC cards, for example, the authentication is normally effected using an algorithm, and the PIN code is used primarily as protection against misuse of the memory card by unauthorized third parties.

In one particularly advantageous embodiment of the present invention, the apparatus has at least one associated memory device which can store information relating to users' access authorization. If goods intended for a purchaser are held and locked up in an inventive apparatus, then it is important that only this purchaser is able to remove the goods, or a person authorized by the purchaser to do so. To this end, the purchaser is provided, for example immediately after the ordering process for the goods, with a code which he/she then needs to input on the apparatus containing the goods intended for him/her. This code naturally also needs to be “known” to the apparatus, to which end, in this advantageous embodiment of the present invention, the code is stored in a memory associated with the apparatus.

So that it is possible for the code which has been input using the input unit to be compared directly with the stored code, it is beneficial if the memory device is connected to the reading device and/or to the input unit.

The present invention is particularly suited to the sale of goods which are needed frequently, such as groceries. In order for the groceries to be kept fresh during storage in the inventive apparatus and not to be subject to the risk of perishing, it is advantageous if the apparatus has a cooling device.

In addition, the aforementioned object is also achieved with a method as mentioned in the introduction by virtue of the invention's arranging and sealing real objects in a sealing apparatus on the basis of a selection by the vendor and, before a purchaser instigates removal, the sealing apparatus authenticates the purchaser, with the sealing apparatus being able to be opened only after successful authentication of the purchaser.

A particular advantage in this context is if the at least one object is selected by the purchaser using an electronic purchasing station; for example, an “e-shop”, provided by a vendor on a WEB page.

Additional features and advantages of the present invention are described in, and will be apparent from, the following Detailed Description of the Invention and the Figures.

### BRIEF DESCRIPTION OF THE FIGURES

FIG. 1 shows a schematic illustration of an apparatus in accordance with the present invention.

FIG. 2 shows a block diagram of an apparatus in accordance with the present invention.

FIG. 3 shows a schematic illustration of a number of apparatuses connected to an account facility, in accordance with the present invention.

FIG. 4 shows an inventive apparatus having an external memory device.

### DETAILED DESCRIPTION OF THE INVENTION

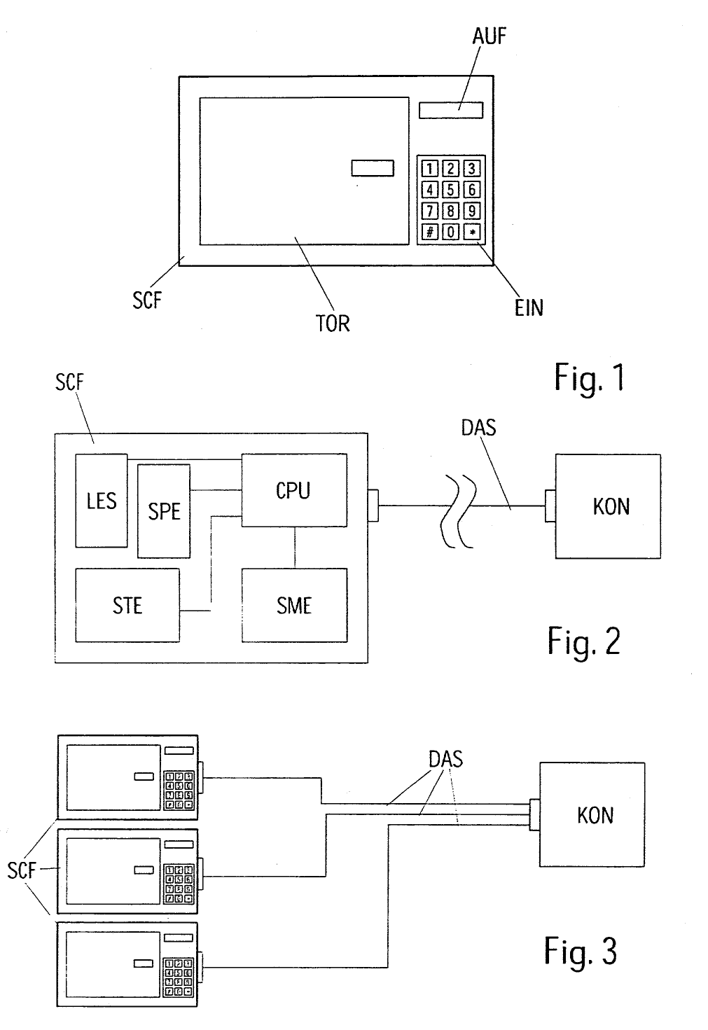

FIG. 1 shows an apparatus in accordance with the present invention for sealing in objects, which will be referred to below as “locker” SCF for short. In one advantageous embodiment, the locker SCF includes at least one interior (not shown), which can store objects, and at least one door TOR for sealing the interior, so that objects cannot be removed by unauthorized people. In addition, in the illustration shown, the locker SCF also has an input EIN with a number of keys, and also a reading device's slot AVF for memory cards.

As also can be seen from FIG. 2 in a schematic illustration, the locker SCF has at least one processor CPU and at least one memory SPE, which are connected to the reading device LES. In addition, a sealing mechanism SME can be seen which is responsible for opening the door and is controlled by the processor CPU.

In accordance with the present invention, goods, such as prepared food or other objects (e.g., electronic appliances) which, as explained in even more detail later, have been ordered from a vendor by a purchaser, are sealed in the locker SCF by the vendor, for example. In addition, the vendor also inputs on the locker those data which need to be known in order to open the door TOR remove the stored objects. Normally, these data are known only to the purchaser besides the vendor, or only the purchaser has the appropriate “information” in order to authenticate himself/herself with the locker SCF; i.e., to claim to be the person who is authorized to remove the objects.

Another option is for the vendor to assign to a locker SCF a known number, such as a customer number, which serves as a “key”, as it were. The purchaser can then effect clear authentication using his/her customer or EC card and his/her customer number (Public-Private-Key method).

In the embodiment of the present invention shown in FIG. 2, this information is stored in the memory SPE in the locker SCF. However, provision also can be made for these data to be stored in an external memory SPX to which the locker SCF is connected via a data line DAS′, as shown in FIG. 4.

The information mentioned above, such as a particular code which the purchaser can use to authenticate himself/herself with the locker SCF, can be input, by way of example, directly using the input EIN on the locker SCF, for example at the time at which the locker SCF is filled with the respective goods. In the case of a data link from the vendor to the locker SCF, this input alternatively can be made conveniently using an input unit, for example a personal computer PEC, linked to this data line DAS′ as appropriate, as can be seen in FIG. 4. In this case, the external memory SPX for the access authorizations is held in the input unit PEC. Alternatively, the situation may be that the external memory SPX is held in a separate unit, such as a data server.

This “input of information” can also take the form that the locker is simply assigned to a particular customer, for example using his/her customer number or customer card, for one or more purchasing operations. Since this information is often stored in a database provided specifically for this purpose, which database can, for the present invention, sometimes be linked to the locker or lockers, the vendor can make the assignment particularly conveniently, since the complexity associated with this procedure is very low.

In particular, it is often beneficial to input the user authorizations (“information”) using a central input, such as a personal computer PEC, in the situation in which a number of inventive lockers SCF are used, as shown in FIG. 4, for example. It can be particularly expedient in this case, in particular, if, as described above for the access authorizations relating to the individual lockers, the access authorizations for the individual purchasers are stored in a central, external memory SPX which is part of a computer server or of the personal computer PEC, for example, although this need not be absolutely necessary.

Alternatively, it can be expedient if a particular locker SCF has merely been assigned the user identifier of just one person; in particular, this can be beneficial when a particular locker is associated with a regular customer, for example, over a relatively long period of time.

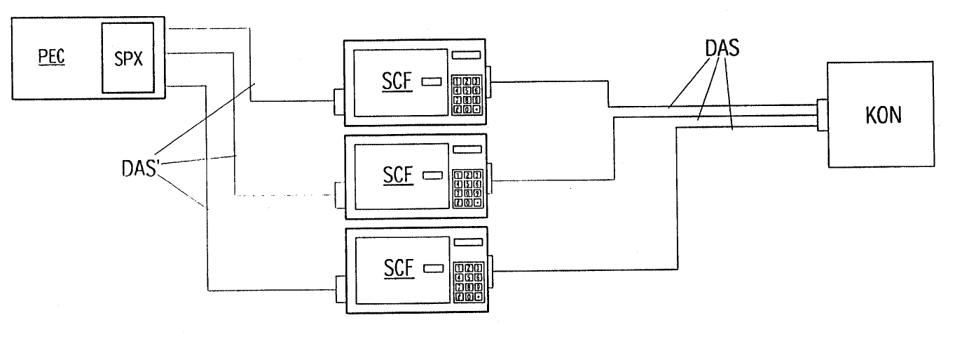

As can be seen, furthermore, from FIGS. 2 and 3, the inventive locker SCF has at least one associated account facility KON. A fundamental part of the present invention is that, essentially at the same time as the locker is opened (virtually at the time at which the goods are “handed over”) the vendor of the goods is credited with a credit sum corresponding to the goods value from the purchaser's funds. Particularly when there is a large number of lockers SCF, it is advantageous in this context, if not every locker has been assigned to a particular purchaser, for the access information to be stored in a central memory SPX, since this is a simple way for the vendor to handle the vending process.

In the example shown, the account facility KON is connected to the locker SCF via a data line DAS, which makes it possible for an account facility to be used for a number of lockers. Alternatively, the account facility can, in principle, be incorporated in a locker.

Since the present invention is of interest particularly for perishable goods, such as a wide variety of prepared foods, it can be advantageous for the interior of the locker SCF to be in the form of a cold store so that there is no immediate danger of the goods perishing. However, this refinement can be regarded as being an additional advantageous form of the present invention which is not absolutely necessary within the scope of the present invention.

For the authentication of a purchaser with a locker SCF, there are various options described below. It is important in this context that, when there is a relatively large number of lockers, the purchaser knows which one holds the goods which are intended for him/her, and that only he/she or a person which he/she has authorized is able to open this locker. The following authentication options are now available:

Within the context of ordering and possibly of order confirmation, the purchaser is informed of a code, for example including a combination of numbers and/or letters, which the purchaser inputs on the appropriate locker. When the code is communicated by e-mail or via an Internet page, for example, it is beneficial for the code to be transmitted in encrypted form.

The purchaser has a customer card which he/she uses to authenticate himself/herself with the locker. To this end, the customer card is inserted into the reader's slot on the locker. The customer card is produced and issued by the vendor or by an issuing center commissioned to do so. The customer card can, by way of example, be a memory card, for example in the form of a known cash-dispenser or EC card. The customer card can be protected from misuse via a PIN code. The memory device SPE, SPX associated with the locker SCF stores the information regarding with which customer card the locker or the content of the locker is associated. If there is more than one locker, one input or reading unit is sufficient for all the lockers in this case, since the locker associated with the customer card opens automatically.

For an account facility for a cash-dispenser cash facility, where the purchaser pays using his/her cash-dispenser card, the authentication also can be effected using the cash-dispenser card (EC card), since this requires that a PIN code for the card be input.

The authentication also can be effected using biometric systems, for example by fingerprint input, iris scan, etc. The appropriate “information” needs to be stored in a database in the memory SPE, SPX in the locker SCF.

Finally, authentication is also possible using a mobile radio, (i.e. with the SIM card (“Subscriber Identity Module”)), and this can then be used for the payment at the same time.

To pay for the goods stored in the locker, there is likewise a number of different possible options, as listed below:

Payment can be made, by way of example, using a cash-dispenser card, irrespective of whether or not this is used for authentication, which is inserted into the reader's slot on the locker. In line with the conventional use of a cash-dispenser card, the purchaser's account is then debited with an equivalent value corresponding to the value of the goods, and this value is credited to an account facility for the vendor. This account facility can be an account for the vendor which is held at his/her bank, for example, but it is normally (as is usual for cash-dispenser cash facilities) a separate memory card to which the respective value is credited. The vendor then uses appropriate, known procedures for actually crediting the credit sum to his/her account at regular times, normally at the end of the day.

The payment is made, by way of example, using a customer card which is in the form of a memory card and has been electronically loaded with a particular credit sum. The electronic loading of this customer card can be performed, by way of example, directly by the vendor, from whom a particular credit sum is purchased in advance, for example. This is very similar to the use of a cash-dispenser or EC card which has been electronically loaded with a particular sum. Upon payment, such an electronic credit sum can be credited to the vendor and can be exchanged for “real” money by him/her at a later time. A cash-dispenser card can be loaded at any cash dispenser, or directly with the trader.

It is also possible to pay using a mobile radio, with the purchaser being debited with the appropriate value of the goods purchased on his/her (monthly) telephone bill. To this end, it is then necessary for the sealing apparatus SCF to have parts for data interchange with mobile radios; i.e., a transmission/reception device, in particular. In this case, authentication is advantageously likewise effected, as already mentioned above, using the mobile radio.

Another payment option involves the purchaser having a current account with the vendor, from which an appropriate sum is debited when the goods are removed following authentication. The locker can be opened only if the account has sufficient funds.

Payment is also possible using a “prepaid” card, as is known from the mobile radio sector, for example. This card has a particular associated credit sum, which sometimes can be reloaded, and the appropriate sum is debited from this prepaid card and is credited to the vendor, i.e. to the vendor's account facility, when the locker is opened.

The text below will give a brief description of the inventive method using an example. In a first step, a purchaser orders from a vendor one or more goods which he has selected in advance. In this case, the selection is made from a catalog, for example. Within the context of the present invention, the goods are particularly advantageously selected over the Internet, for example using a supplier's “electronic shop”, which is then also used immediately to order the goods.

When the goods are ordered using such an “electronic shop”, the goods on a corresponding Internet page for the vendor are placed into a “basket” via suitable input actions on the supplier's Internet page. A confirmation action, for example the pressing of an “OK” button, is then used to order the objects which have been placed in the basket. Other options for ordering are, naturally, also telephone ordering or ordering by telephone, e-mail, using WAP (“Wireless Application Protocol”) or SMS (“Short Message Service”). It is also conceivable for a catalog or handheld computers (also PDAs, such as from Psion or Palm) to be used for ordering. In the latter case, the order could be given by synchronizing the handheld with a personal computer having active Internet access. Alternatively, the order could be given using a mobile radio, such as that which communicates with the handheld via an infrared interface (or radio, wire interface, etc.), or using a direct link from the handheld to the Internet, or more generally an appropriate data line.

Besides indicating the goods required, ordering also requires the vendor to be informed of the purchaser's identity so that the vendor can allocate the ordered goods as appropriate. To this end, the purchaser can add, by way of example, his name, possibly with an address or other information, such as his/her e-mail address. If orders are placed regularly, however, it is found to be beneficial for a purchaser to have his/her own customer number which is used for ordering.

When the vendor has received the order, the goods are put together in line with the goods indicated in the order. If certain goods are not available, the vendor can offer an alternative to the purchaser, such as via e-mail or SMS, which the purchaser can accept or reject; for example, by not responding. The goods put together are then placed in the locker SCF by the vendor, as described in detail above, and the locker SCF, which in principle is accessible to a large number of people, of course, is sealed, so that it can be opened only by a person (or group of people) authorized to do so. Normally, the order is confirmed to the purchaser, and at the same time, when there is more than one locker SCF available, the purchaser is informed of which of the lockers contains his/her goods.

At a time suitable to the purchaser, the purchaser can pick up the goods from the locker SCF intended for him/her. The purchaser authenticates himself/herself with the locker; for example, via a code of which he/she has been notified previously or by inserting his/her customer card into the slot AUF on the locker. If the code which has been input is correct or if the customer card has been inserted into the correct locker, all that is now necessary is the payment. This can be made in various manners as described above; for example, using the customer card (or cash-dispenser or EC card) which was also used for authentication. When this payment has been made, the locker can be opened and the goods it contains can be removed, or the payment is made at the moment at which the locker is opened.

In conclusion, the following will be noted: the type of ordering is, in principle, of secondary importance in the case of the present invention. However, the present invention is of particular advantage in connection with “e-shops”, that is to say the ordering of goods over the Internet. As far as payment is concerned, it is not absolutely necessary for the payment per se to be made at the moment at which the locker is opened or immediately beforehand, but rather it is just necessary for a credit sum corresponding to the goods value to be credited to the vendor.

It also will be stated here that, although the drawings show lockers SCF with dedicated inputs EIN and dedicated readers, it is also possible in practice for just one central input and also just one central reader to be provided for a number of lockers.

Finally, it also will be noted that “credit” within the context of the description and of the claims is to be understood to mean that either a money transaction actually takes place, or that, by way of example, there is merely a check on whether the account has sufficient finds, and the account is later debited in favor of the vendor.

Although the present invention has been described with reference to specific embodiments, those of skill in the art will recognize that changes may be made thereto without departing from the spirit and scope of the present invention as set forth in the hereafter appended claims.

1. An apparatus for sealable storage of objects, comprising:
parts for checking an opening authorization;
parts for allowing opening only following positive authentication of a user; and
an associated account facility which can be credited with at least one credit sum corresponding to a value of the stored objects.

2. An apparatus for sealable storage of objects as claimed in claim 1, wherein opening is enabled only after the credit sum has been credited.

3. An apparatus for sealable storage of objects as claimed in claim 1, wherein the credit sum is credited at a moment of opening.

4. An apparatus for sealable storage of objects as claimed in claim 1, wherein the account facility is separate from the apparatus and is connected thereto via a data line.

5. An apparatus for sealable storage of objects as claimed in claim 1, wherein the account facility contains at least one trader memory card which is credited with the credit sum.

6. An apparatus for sealable storage of objects as claimed in claim 1, further comprising at least one reading device for customer memory cards.

7. An apparatus for sealable storage of objects as claimed in claim 6, wherein the reading device is connected to the account facility and the value of the stored objects is credited using the memory card.

8. An apparatus for sealable storage of objects as claimed in claim 6, wherein the opening authorization is checked using the memory card.

9. An apparatus for sealable storage of objects as claimed in claim 8, further comprising at least one input unit.

10. An apparatus for sealable storage of objects as claimed in claim 8, wherein the apparatus compares an identifier which has been input using the input unit with an identifier stored on the memory card.

11. An apparatus for sealable storage of objects as claimed in claim 1, further comprising at least one associated memory device for storing information relating to users' access authorization.

12. An apparatus for sealable storage of objects as claimed in claim 9, wherein the memory device is connected to at least one of the reading device and the input unit.

13. An apparatus for sealable storage of objects as claimed in claim 1, further comprising a cooling device.

14. A method for purchasing objects, the method comprising the steps of:
arranging and sealing real objects in a sealing apparatus according to a selection by a vendor; and
authenticating a purchaser, via the sealing apparatus and before the purchaser instigates removal, with the sealing apparatus being able to be opened only after successful authentication of the purchaser.

15. A method for purchasing objects as claimed in claim 14, the method further comprising the step of selecting at least one object by the purchaser using an electronic purchasing station.

16. A method for purchasing objects as claimed in claim 14, the method further comprising the step of crediting a value corresponding to the objects to an account facility associated with the sealing apparatus at a time which is one of when the sealing apparatus is opened and immediately after when the sealing apparatus is opened.

17. A method for purchasing objects as claimed in claim 14, wherein an opening is possible only after a credit sum has been credited.

18. A method for purchasing objects as claimed in claim 14, wherein a credit sum is credited at a moment of opening.

19. A method for purchasing objects as claimed in claim 14, the method further comprising the step of using an account facility which is separate from the sealing apparatus and is connected thereto via a data line.

20. A method for purchasing objects as claimed in claim 14, the method further comprising the step of crediting a credit sum to a trader memory card contained in an account facility.

21. A method for purchasing objects as claimed in claim 14, wherein the sealing apparatus includes at least one reading device for customer memory cards.

22. A method for purchasing objects as claimed in claim 21, wherein the reading device is connected to the account facility, and a goods value is credited using the memory card.

23. A method for purchasing objects as claimed in claim 21, wherein opening authorization is given using the memory card.

24. A method for purchasing objects as claimed in claim 21, wherein the sealing apparatus includes at least one input unit, with an identifier which has been input using the input unit being compared with an identifier stored on the memory card.

25. A method for purchasing objects as claimed in claim 14, wherein the sealing apparatus includes a memory device which can store information relating to users' access authorization.

26. A method for purchasing objects as claimed in claim 25, wherein the memory device is connected to at least one of the reading device and the input unit.
